(19) United States
(12) Patent Application Publication
(10) Pub. No.: US 2008/0319858 A1
(43) Pub. Date: Dec. 25, 2008

(54) AUTOMATED SYSTEM TO DETERMINE, STORE, AND SHARE THE RELEVANCE OF INFORMATION, AND TO ASSIGN TRUST TO THAT INFORMATION

(76) Inventor: William E. DENK, JR., Hanover, PA (US)

Correspondence Address: MCGUIREWOODS, LLP, 1750 TYSONS BLVD, SUITE 1800, MCLEAN, VA, 22102, US

(21) Appl. No.: 12/140,240

(22) Filed: Jun. 16, 2008

Related U.S. Application Data
(60) Provisional application No. 60/934,487, filed on Jun. 14, 2007.

(51) Int. Cl. G06Q 30/00; G06F 7/06; G06F 17/30

(52) U.S. Cl. 705/14; 707/5; 707/E17.014

(57) ABSTRACT

A system includes a relator configured to receive data from an external source, a data store configured to store the data, a first processor to assign a relevance value to each of the stored data, a transceiver to receive a query for data meeting certain criteria, and a second processor to analyze the relevance value of each of the stored data in order to determine whether the certain criteria are met. The system automatically determines, stores, and shares relevant information by establishing trusted relationships.

### CROSS REFERENCE TO PRIOR APPLICATIONS

This application claims priority and the benefit thereof from U.S. Provisional Application No. 60/934,487, filed on Jun. 14, 2007, which is hereby incorporated by reference for all purposes as if fully set forth herein.

### BACKGROUND OF THE INVENTION

1. Field of the Invention

The invention is directed generally to a system and method of providing relevant information, and, more particularly, to determining, storing, and sharing the relevance of information, and assigning a value to the relevance of the information.

2. Related Art

When making certain decisions, people often rely on a trusted source of information to inform their decision. This trusted source may be a perceived expert in the field, or may be a friend, colleague, or family member who has previously provided valuable information in the field. For example, when deciding upon a mortgage broker, a home buyer may ask his real estate agent for a referral, on an assumption that the agent has significant experience with various mortgage brokers, and can recommend the best broker for the buyer's situation. Other examples of perceived experts in their respective fields include movie and book critics, restaurant critics, and car and stereo specialty magazines. As another example, when deciding upon a new book to read, a reader may ask a friend, colleague, or family member who has previously recommended books that the reader has enjoyed.

Historically, though, this method of obtaining information has been limited in at least four ways. First, the person seeking a referral in order to make an informed decision may not know all of the qualifications and experiences of all of his contacts. For example, he may not know that his friend's wife works for a mortgage broker, and knows the reputations of all the local firms.

Second, such information is not always timely received. For example, a reader may normally solicit book recommendations from relatives at holiday meals. Hence, when preparing for her summer vacation, she may stop by a book store, and wonder what she should buy, not having her trusted sources of information at her disposal.

Third, no record is kept of the value of the recommendation. For example, a person might or might not remember that a particular friend recommended three movies, and that the person enjoyed all three movies immensely. When the friend later recommends a fourth movie, the person might not know what value to place on the recommendation: is the friend a trusted source of movie recommendations, or does the friend have different tastes?

Fourth, the known methods are limited in scope to the acquaintances, friends, colleagues, and relatives of the person seeking input on his decision. These known people may be referred to as the user's “first degree” relationships, and the people who are known to the user's first degrees may be referred to as “second degree” relationships, etc.

Services such as Amazon.com® and others have attempted to capitalize on and improve such referral methods by encouraging buyers to review, rate, or comment on particular products or services. For example, if a buyer sees rave reviews from numerous unknown other buyers, the buyer may be more inclined to purchase the item. However, these methods are also limited in several ways. First, the people giving the recommendations cannot be ranked by level of trust. A buyer cannot know whether he will have the same interests, or needs, or sense of humor as the person giving the recommendation. Second, the buyer cannot evaluate the recommender's expertise, credentials, or skill level from such recommendations.

Accordingly, there is a need for a system and method to determine the relevance of information, store that information until needed, share the information with other people as appropriate, and assign a value to the relevance of the information.

### SUMMARY

The invention meets the foregoing need and avoids the disadvantages and drawbacks of the prior art by providing a system and method to determine the relevance of information, store that information until needed, share the information with other people as appropriate, and assign a value to the relevance of the information. The novel system and method of the invention result in a significant improvements in efficiency, satisfaction, and ease of communication, as well as other advantages apparent from the discussion herein.

Accordingly, in one aspect of the invention a system includes a relator configured to receive data from an external source, a data store configured to store the data, a first processor to assign a relevance value to each of the stored data, a transceiver to receive a query for data meeting certain criteria, and a second processor to analyze the relevance value of each of the stored data in order to determine whether the certain criteria are met.

According to another aspect of the invention method includes capturing data from an external source to a relator, storing the data, assigning a relevance value to each of the stored data, receiving a query for data meeting certain criteria, wherein one of the criteria is source of the data, and analyzing the relevance value of each of the stored data in order to determine whether the certain criteria are met.

In yet another aspect of the invention a machine-readable medium comprising instructions, which, when executed by a general-purpose processor cause the general-purpose processor to provide information, the instructions including instructions for capturing data from a source external to the system to a relator, instructions for storing the data in the system, instructions for assigning a relevance value to each of the stored data, instructions for receiving a query for data meeting certain criteria, wherein one of the criteria is source of the data, and instructions for analyzing the relevance value of each of the stored data in order to determine whether the certain criteria are met.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 is a flow chart showing an example of a system for capturing information from an external source, storing the information, and assigning relevance thereto;

FIG. 2 is a flow chart showing an example of a system for retrieving information from the system and providing it to a user who previously located it and/or a user who had not previously located it;

FIG. 3 is a flow chart showing an example of a system for identifying an expert in a particular field;

FIG. 4 is a flow chart showing an example of a system for identifying group relationships;

FIG. 5 is a flow chart showing an example of a system for providing filtered results to a source outside of the system;

FIG. 6 is a flow chart showing an example of a system for providing filtered results in response to access to the system through a source outside the system; and

FIG. 7 is a flow chart showing an example of a system for providing information to or fulfilling a request of a source outside of the system.

### DETAILED DESCRIPTION

The embodiments of the invention and the various features and details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure teaching principles of the disclosed embodiments. The examples used herein are intended merely to facilitate an understanding of ways in which the disclosure may be practiced and to further enable those of skill in the art to practice disclosed the embodiments. Accordingly, the examples and embodiments herein should not be construed as limiting. Moreover, it is noted that like reference numerals represent similar parts throughout the several views of the drawings.

The present invention allows users to obtain information such as detailed information about products or services, referrals or recommendations, relevance information (which may also be referred to as a relevance value, or a confidence value), and the like. The information may be accessible virtually 24 hours a day, seven days a week, through a communication device, including, e.g., a mobile telephone, desktop computer, laptop computer, a Personal Digital Assistant (PDA), a notebook computer, an SDR radio, a work station, a television, or the like. A user may obtain information at his own convenience, even when other users are not available to give information in real time.

A user may limit the information obtained to only information that meets certain search criteria. The results may be limited to information that was previously submitted by people he knows, that is, his first degree relationships, or the results may be expanded to include information previously submitted by people known to the people he knows, that is his second degree relationships, etc., and may even include all information that meets his search criteria.

In an embodiment, the invention may track the user's receipt of information and subsequent evaluation of this information, creating a feedback loop that thus provides the user with more relevant information with each use of the system. For example, when a first user seeks a recommendation for a movie, he can query the system for recommended movies. After he receives certain recommendations, makes his decision based on the recommendation of a second user, and then watches the movie himself, he can then submit information about the movie to the system. That is, if the user enjoyed the movie, then he can add the movie to the list of those he recommends, and the system can correlate the recommendation that he gave with the recommendation he received. Thus, when the user seeks a second recommendation for a movie, any other recommendations given by the second user may be given stronger weight, or higher relevance, than recommendations given by other sources. This feedback may be topic specific, that is, a user may weigh movie recommendations from his sister heavily, but may also weigh book recommendations from his college roommate more heavily.

In another embodiment, a user may limit access to only certain authorized users. For example, a user may limit access to his recommendations and referrals to only those within two degrees of separation from himself.

In another embodiment, the system may use geo-location information, such as information obtained from a Global Positioning Satellite (GPS), as one of the search criteria. For example, a user accessing the system through a mobile device may request recommendations on restaurants in the area near his current location. In response, the system may learn his current location by accessing geo-location information on his mobile device, examine the other search criteria, and provide only the more relevant results. A mobile device may include any machine, device, circuit, component, or module, or any system of machines, devices, circuits, components, modules, or the like, which are capable of receiving and/or sending data, and which are further capable of manipulating data according to one or more instructions, such as, for example, without limitation, a processor, a microprocessor, a central processing unit, a general purpose computer, a personal computer, a laptop computer, a palmtop computer, a notebook computer, or the like, or an array of processors, microprocessors, central processing units, general purpose computers, personal computers, laptop computers, palmtop computers, notebook computers, or the like. For example, a mobile device may include, without limitation, a smart telephone, a cellular telephone device, a satellite telephone device, a cordless telephone, a software-defined-radio (SDR), a two-way radio, a personal data assistant (PDA), a game console, a game controller, or the like. The results may be provided based on other pre-determined search criteria.

In yet another embodiment, a user may obtain results from multiple other users simultaneously, particularly when searching for a consensus on a topic. Thus, for example, a user may solicit recommendations for a local dentist, and the results may be displayed in a ranked order, e.g., ranking the first dentist as the one most frequently recommended, and the last as the least frequently recommended.

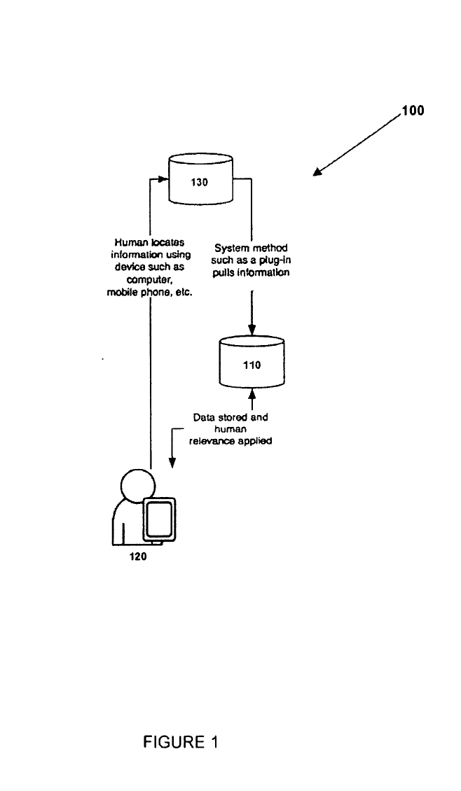

Referring to FIG. 1, a flow chart shows an example of a system 100 for capturing information from an external source 130, storing the information, and applying relevance thereto. In this embodiment, the system 100 may include information regarding each user, groups of users, and the relationships between the users. The relationships between the users may fall into one or more of the following categories, but are not limited to these categories: colleague, acquaintance, classmate, neighbor, friend, relative, or other type of earned trust. The information may be any form of data, including but not limited to text, image, audio, video, web pages, opinions, feedback, recommendations, and referrals. The information may further include metadata such as the relevance or value of each datum, which may be obtained from the feedback mechanism described above. The relevance or value may be assigned by a user, and/or may be determined by the system 100 based upon interactions between users.

Referring again to FIG. 1, the user 120 may seek information. The user 120 may access the system directly, or through a network. The network may include, but is not limited to, for example, any one or more of a personal area network (PAN), a local area network (LAN), a campus area network (CAN), a metropolitan area network (MAN), a wide area network (WAN), a broadband network (BBN), the Internet, or the like. Further, the network may include, but is not limited to, for example, any one or more of the following network topologies, including a bus network, a star network, a ring network, a mesh network, a star-bus network, tree or hierarchical network, or the like.

For example, the user 120 may seek a well qualified real estate agent with experience selling high-end homes in the user's neighborhood. When the user 120 finds the information the user 120 seeks, that information may be entered into the data store 110. For example, the user 120 may conduct an online search, from which the user 120 may find an article in a local paper identifying the top real estate agents in the user's area. If this information was electronically generated, the system 100 may capture this information automatically; alternatively, if the user 120 obtained this information from a printed paper, or other non-electronic format, the user 120 may enter the information into the system 100 manually. The system 100 may then store the information, as well as specific inherent characteristics of the information, in the data store 110. For example, in the case of a graphic found on an external source 130, such as, e.g., the Internet, these characteristics may include data such as: size of a file; type of a file; creation date of a file; location (URL) of a file, or the like. In addition, the user 120 may assign additional data the user 120 considers relevant to this information such as: key words or tags describing the data, or a memorable name for later retrieving the information, or the like.

The information may be available in a file or record associated with the particular user 120. The file or record may be retained indefinitely, allowing the user 120 to access it from any device that can connect to the system 100 such as a computer and a browser, a mobile phone and a software application (such as a mobile browser) that can view the Internet, or the same or similar which can view an internal network or other system, or any other device or application that can be so connected. The user 120 may group this information with other information that the user 120 may have captured, or found within the system 100 and deemed relevant using, for example, a folder, grouping, assignment, or the like, and assign additional data that the user 120 may consider relevant to the group. The user 120 may share this information with other users, or may restrict access thereto.

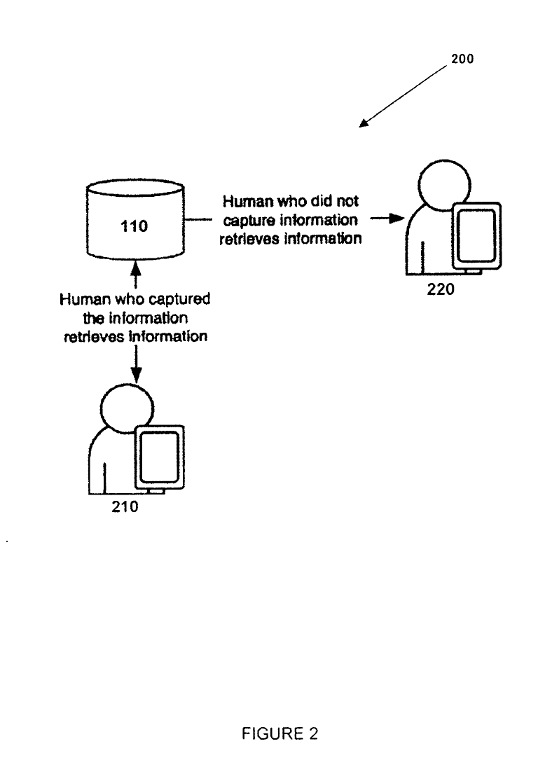

Referring to FIG. 2, a flow chart shows an example of a system 200 for retrieving information, and providing the information to a user 210. The user receiving the information may be a first user 210, who had previously captured the information. For example, after identifying a qualified real estate agent, the user 210 may save the information, and return to it later when ready to act on the information. The user receiving the information may alternatively be a second user 220, who is likewise seeking a qualified real estate agent in his neighborhood, and who is authorized to see the first users (210) recommendations. That is, unless access to the information is restricted, other users that have access to the system 200 will be able to view it, and if allowed, will have full access to maintain or modify the additional assigned data by the first user 210, within an account associated with user 210. When a second user 220 retrieves, views, and/or saves the first user's (210) previously captured information to an account associated with the second user 220, the system may automatically increase the value of the information.

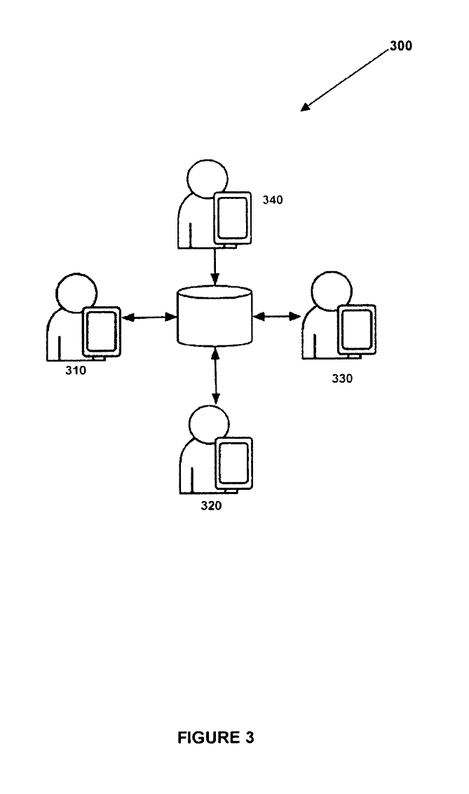

Referring to FIG. 3, a flow chart shows an example of a system 300 for identifying an expert in a particular field. In this embodiment, a first user 310 may know and have great trust in a second user 320, and a third user 330, since both users 320 and 330 in the first user's (310) first degree. The second user 320 may have less trust in the third user 330 and vice-versa, because they are in the second degree of each other. As degrees continue to progress, anonymity may become greater and trust may become less. In this embodiment, the second user 320 may be seeking a real estate agent having certain qualifications. An expert user 340 having those qualifications may have been identified by the third user 330. Although the second user 320 might not otherwise have any trust in recommendations of the third user 330, because the second user 320 trusts the first user 310, and the first user 310 trusts the third user 330, the second user 320 may weigh the third user's (330) recommendations more heavily by extension of the trust placed in the first user's (310) recommendations. As discussed above, the level of trust assigned to this expert user 340 in this field may be further increased by the number of successful recommendations.

In an embodiment, in the event that a user has looked for information within the system and cannot locate what they are looking for, the system may retain the query until a match is found. A user may also authorize another user to see their information request and fulfill it through existing information in the system, or by capturing the information via an external source. In addition, a first user can submit an information request to another user or users or groups within their first degree relationships. If those users or groups cannot fulfill the information request, they can pass it on to their first degree relationships, unless restricted by either the user initially requesting the information, or by a user in their first degree who is blocking such requests. Additionally, it should be noted that the system 300 may facilitate a first user “introducing” a second user to a third user, such that, although the second and third users may not have previously known each other or been acquainted, their relationship may be changed to one of first degree.

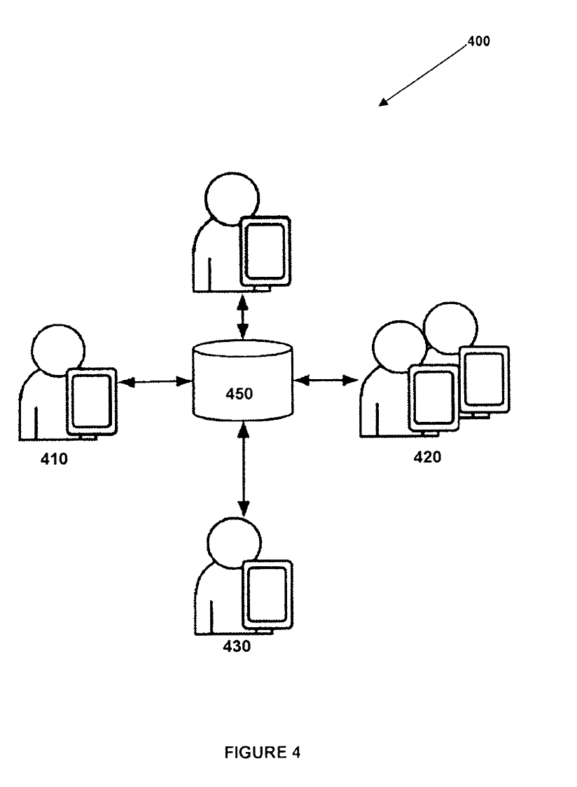

Referring to FIG. 4, a flow chart shows an example of a system 400, including a relator 450 for identifying group relationships. The relator 450, according to a preferred embodiment of the invention, includes a computer (not shown), a data store (not shown), and a communications interface (not shown). The computer may include any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a personal computer, a laptop computer, a palmtop computer, a notebook computer, a desktop computer, a workstation computer, a server, or the like, or an array of processors, microprocessors, central processing units, general purpose computers, personal computers, laptop computers, palmtop computers, notebook computers, desktop computers, workstation computers, servers, or the like. The data store may include a database, a plurality of databases, a plurality of relational databases, or the like. The communications interface is configured to interface with any network protocol.

In an embodiment, a user group 420 may take on the same characteristics as an individual user, including an expert group 440. For example, a first group 420, may exchange information with a first user 410 or a second user 430. The group's values may be determined by the users within the group 420, and the group's relationship to other users. A group's value may also be determined automatically by the value(s) that the members of the group 420 have provided to other users 410, 430 and groups 440 within the system 400, including but not limited to the amount of information they have provided, the relevance and value of each datum, etc.

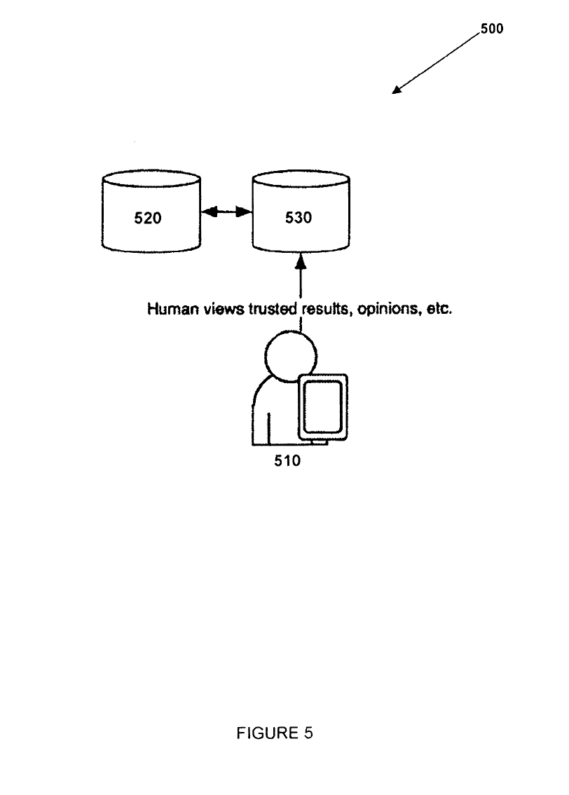

Referring to FIG. 5, a flow chart shows an example of a system 500, including a relator 520 for providing filtered results to a user 510 accessing the system 500 through a source 530 external to the relator 520. In an embodiment, an external source 530 may be connected directly to the relator 520 and provide trusted results to the user 510. For example, if the user 510 has an account with Amazon.com® and visit's that web site, Amazon.com may display a slider or other device through an API (or other method as agreed between the system and the external source) that would allow the user 510 to view information, opinions, recommendations, etc. about a certain product or service offered by Amazon.com by those trusted relationships one degree, or multiple degrees from the user 510. Thus, the external source 530, such as, e.g., Amazon.com, may interact with the system 500 to gain knowledge and information that may assist users in making purchases, or even to offer incentives to users, or rewards to those relationships that promoted the external source, their product or service.

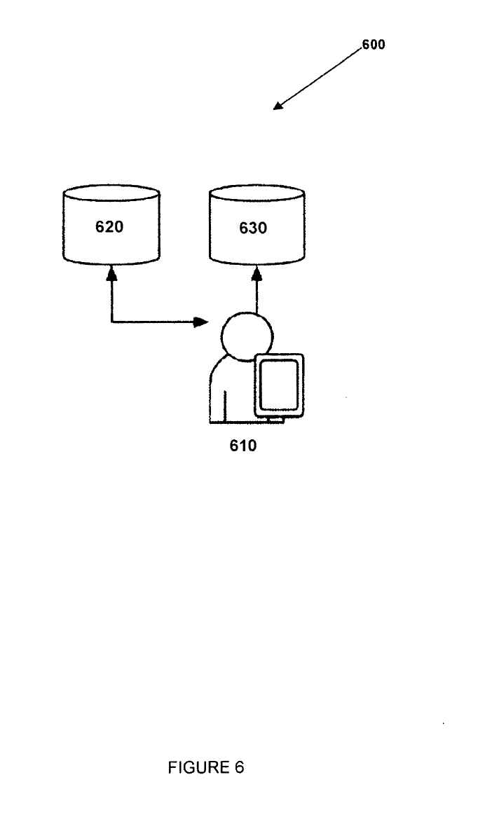

Referring to FIG. 6, a flow chart shows an example of a system 600 for providing filtered results in response to access to a relator 620 through a source 630 outside the relator 620. In an embodiment, a user 610 may access the information on external sources 630 directly through a method, such as, e.g., a plug-in. While this method is related to that discussed with respect to FIG. 5, it differs in that in this embodiment the information provided by the system 600 would not be visible to the external source 630. It should be noted, though, that interaction between an external source 630 and the relator 620 are possible in this embodiment with, e.g., the plug-in, in a reverse manner to that described with respect to FIG. 5 above, by including the external source's (630) API into the relator 620.

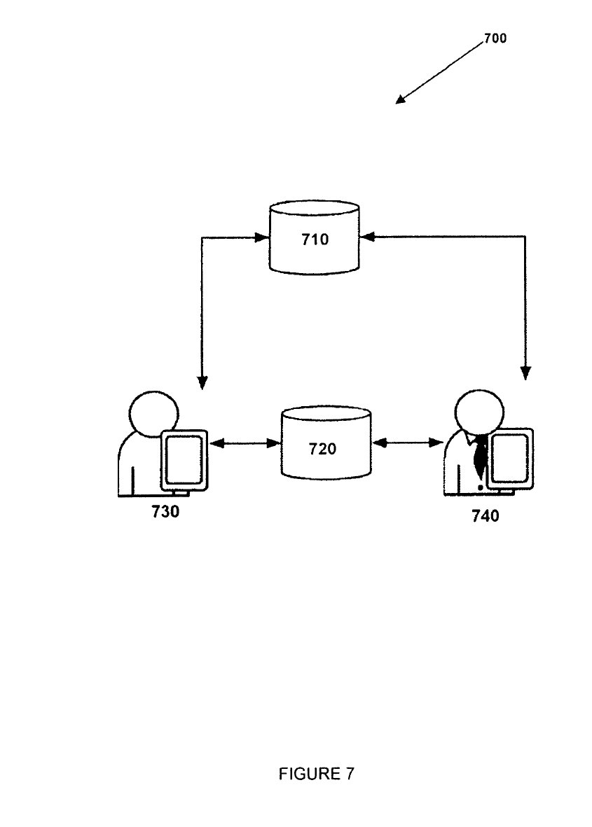

Referring to FIG. 7, a flow chart shows an example of a system 700 for providing information to or fulfilling a request of a source 710 outside of the relator 720. In the event that a user 730 visits an external source 710 (e.g., a web site) and the external source 710 has a connection with the relator 720 through the user 730 or a group 740 (such as the business that controls the web site), the relator 720 will allow the user 730 to provide information such as, but not limited to feedback and opinions, to a second user 750, the group 740, or the external source 710.

In addition, if the profile of a first user meets specific criteria set by a second user or external source, the system may provide a highly targeted offer, incentive, or valued item to the first user. The first user may choose to accept the incentive or alternatively, may pass the incentive on to a third user that they believe could use such an incentive. As an example, when a user visits an external source, such as the web site www.Porsche.com, if the user meets certain criteria previously set by a second user or external source, the system may provide an incentive for the user to give feedback on the external source, or provide other incentives encouraging the user to take a desired action whether online, or in the physical world (such as, offering an opportunity to test drive a 911 Cabriolet for a month).

However, when the user either accepts or rejects such an incentive, the system may note the action taken, such that the incentive will not be offered again unless overridden by the offeror. That is, if the user accepts the offer, then the user may be prevented from taking advantage of the offer repeatedly; conversely, if the user rejects the offer, the user may not repeatedly be offered the same unwanted incentive.

What is claimed is:

1. A system to provide information, the system comprising:
a relator configured to receive data from an external source;
a data store configured to store the data;
a first processor to assign a relevance value to each of the stored data;
a transceiver to receive a query for data meeting certain criteria; and
a second processor to analyze the relevance value of each of the stored data in order to determine whether the certain criteria are met.

2. The system according to claim 1, further comprising a transmitter for sending the results of the analysis to a remote system.

3. The system according to claim 1, wherein the relevance value comprises feedback regarding the use of the information.

4. The system according to claim 1, wherein one of the criteria is the source of the data.

5. The system according to claim 1, wherein one of the criteria is the relevance value assigned to the data.

6. The system according to claim 1, wherein the results comprise an incentive.

7. The system according to claim 1, further comprising a receiver configured to capture data regarding action taken in response to the results provided.

8. A method of providing information comprising the steps of:
capturing data from an external source to a relator;
storing the data;
assigning a relevance value to each of the stored data;
receiving a query for data meeting certain criteria, wherein one of the criteria is source of the data; and
analyzing the relevance value of each of the stored data in order to determine whether the certain criteria are met.

9. The method according to claim 8, further comprising transmitting the results of the analysis to a remote system.

10. The method according to claim 8, wherein the relevance value comprises feedback regarding the use of the information.

11. The method according to claim 8, wherein one of the criteria is the source of the data.

12. The method according to claim 8, wherein one of the criteria is the relevance value assigned to the data.

13. The method according to claim 8, wherein the results comprise an incentive.

14. The method according to claim 8, further comprising a receiver to capture data regarding action taken in response to the results provided.

15. A machine-readable medium comprising instructions, which, when executed by a general-purpose processor cause the general-purpose processor to provide information, the instructions comprising:
instructions for capturing data from a source external to the system to a relator;
instructions for storing the data in the system;
instructions for assigning a relevance value to each of the stored data;
instructions for receiving a query for data meeting certain criteria, wherein one of the criteria is source of the data; and
instructions for analyzing the relevance value of each of the stored data in order to determine whether the certain criteria are met.

16. The machine-readable medium according to claim 15, wherein said instructions further comprise instructions for transmitting results to a remote system.

17. The machine-readable medium according to claim 15, wherein the relevance value further comprises feedback regarding the use of the information.

18. The machine-readable medium according to claim 15, wherein one of the criteria is the source of the data.

19. The machine-readable medium according to claim 15, wherein the results comprise an incentive.

20. The machine-readable medium according to claim 15, further comprising instructions for capturing data regarding action taken in response to the results provided.
